(19) United States
(12) Patent Application Publication
(10) Pub. No.: US 2013/0319442 A1
(43) Pub. Date: Dec. 5, 2013

(54) PEDICURE CART WITH NAIL CURING SYSTEM

(71) Applicant: Linda Ma, Las Vegas, NV (US)

(72) Inventor: Linda Ma, Las Vegas, NV (US)

(21) Appl. No.: 13/486,412

(22) Filed: Jun. 1, 2012

(51) Int. Cl. A45D 29/00; B62B 5/00

(52) U.S. Cl. 132/200; 280/32.5

(57) ABSTRACT

A pedicure cart with an integrated curing device supports a client's feet at an ideal position for a pedicure treatment while allowing one or more toenail coatings to be quickly and properly cured, ensuring pedicure treatments of a consistent quality. The pedicure cart also is configured to support a technician and positions the client's feet at an elevated position within easy reach of the technician to aid the technician in providing a pedicure.

### BACKGROUND OF THE INVENTION

1. Field of the Invention

The invention relates to pedicure application systems and methods, and in particular to a pedicure cart with a nail curing system.

2. Related Art

Pedicures are popular day spa treatments that are desirable as part of a day spa experience and for their aesthetic appearance enhancing qualities. To maximize client satisfaction, it is important that a pedicure is properly applied. To build good will for a day spa brand, it is important that pedicures are applied consistently to ensure clients receive the same quality pedicure for each day spa visit.

From the discussion that follows, it will become apparent that the present invention addresses the deficiencies associated with the prior art while providing numerous additional advantages and benefits not contemplated or possible with prior art constructions.

### SUMMARY OF THE INVENTION

A pedicure cart with a curing system is disclosed herein. The pedicure cart provides supports for a technician and client during a pedicure treatment. The curing system allows toenail coatings or other treatments to be quickly and properly cured. In addition, the supports and curing device are positioned on the pedicure cart to help ensure technician and client comfort. The client's feet (together or individually) are supported at an elevated position where the technician can easily apply pedicure treatments, allowing the pedicure treatments to be applied with a consistent quality.

The pedicure cart may have a variety of configurations. For instance, in one exemplary embodiment, a pedicure cart may comprise a body having a front and a back end, a seat at the back end configured to support a technician, and a footrest at the front end configured to support at least one of a client's feet. The footrest may be elevated above the seat to support the at least one of the client's feet at an elevated position. It is noted that a top portion of the body may be lower at the back end than at the front end of the pedicure cart to aid in elevating at least one of the client's feet.

A curing device may be at the front end configured to accept at least a portion of the at least one of the client's feat. One or more wheels may be attached to a bottom portion of the body to provide mobility. A support surface configured to support one or more technician tools thereon may be between the seat and footrest.

It is noted that a cavity may be in the body to support the curing device. An opening in the top of the body may be provided to allow access to one or more controls of the curing device. The curing device will typically be positioned below the footrest and have an opening at the front end of the pedicure cart.

In another exemplary embodiment, a pedicure cart may comprise a seat at a back portion of the pedicure cart, a footrest configured to support at least one foot at an elevated position above the seat at a front portion of the pedicure cart, and a curing device having an opening to accept the at least one foot. The opening will typically be positioned at the front portion of the pedicure cart.

A body of the pedicure cart may be configured to support the seat and the footrest. The body may have a cavity therein configured to accept and support the curing device. It is noted that the curing device may comprise a curing element selected such as a heater, a light, a fan, or various combinations thereof.

One or more wheels may be attached to a bottom portion of the body to allow the pedicure cart to be mobile. At least one of the wheels may have a brake. One or more compartments configured to store one or more technician tools may be in the cavity. The seat may be padded, and similarly the footrest may comprise a pad.

Various methods of providing a pedicure treatment are disclosed herein as well. In one exemplary embodiment, a method of providing a pedicure treatment using a pedicure cart may comprise supporting at least one of a client's feet at an elevated position on a footrest at a front end of the pedicure cart, and applying one or more toenail treatments to the at least one of the client's feet while the at least one of the client's feet are on the footrest.

The at least one of the client's feet may be from the elevated position to allow the at least one of the client's feet to be received in a curing device at the front end of the pedicure cart. The curing device will typically have an opening to accept the at least one of the client's feet below the footrest. The curing device may be activated to cure at least one of the toenail treatments.

One or more tools may be placed on a work surface of the pedicure cart that is located adjacent the footrest, with the tools being used to apply the toenail treatments. Also or alternatively, the tools may be retrieved from a cavity in a body of the pedicure cart.

It is noted that the method may also include moving the pedicure cart to a client's chair on one or more wheels of the pedicure cart, and/or sitting on a seat located at a back end of the pedicure cart, wherein the elevated position is above the seat.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of an exemplary pedicure cart with a nail curing system;

FIG. 2 is a perspective view of an exemplary pedicure cart with a nail curing system;

FIG. 3 is a side view of an exemplary pedicure cart with a nail curing system in operation; and

FIG. 4 is a side view of an exemplary pedicure cart with a nail curing system in operation.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Generally speaking, the pedicure cart herein provides a tool for application of pedicures by a technician. The pedicure cart is advantageous in that it positions a client's foot at an ideal position for the technician. This reduces discomfort and fatigue for the technician. In addition, the pedicure cart includes a curing system which is used to set nail treatment's applied to a client's toenails. These features help ensure quality and consistency of the pedicures provided on the pedicure cart.

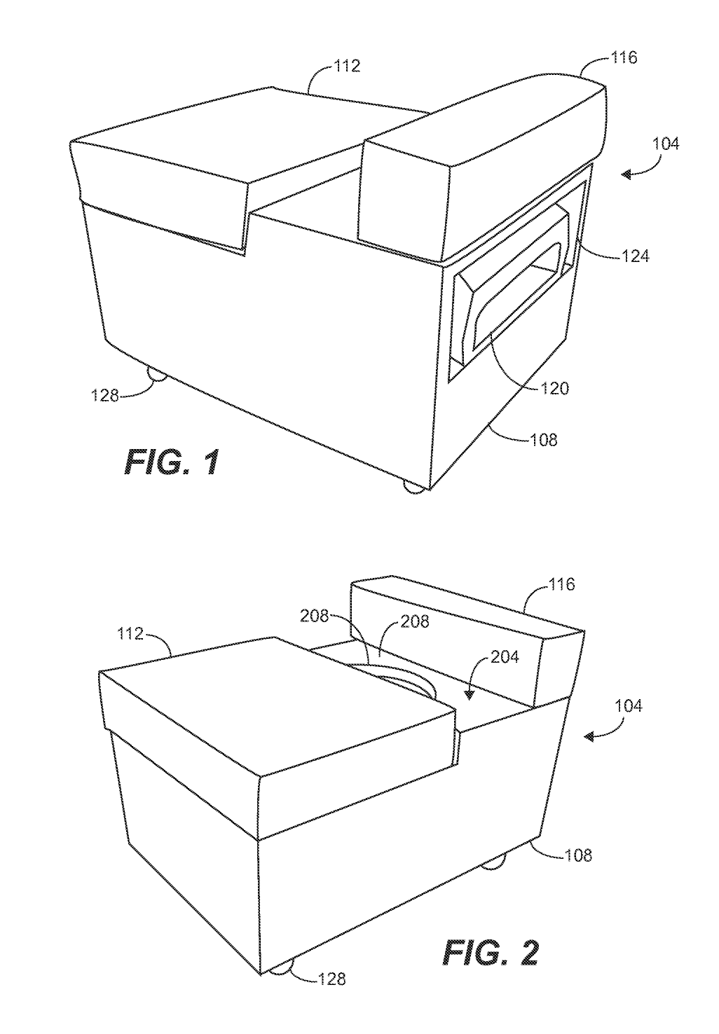

The pedicure cart will now be described with regard to FIG. 1. As can be seen, a pedicure cart 104 may comprise a body 108 that provides support for a technician and for a client's feet (or foot if one foot is placed on the pedicure cart at a time). Support for the technician may be provided via a seat 112 positioned at the rear of the pedicure cart 104. The seat 112 may be padded in one or more embodiments. As will be described further below, a technician may sit on the seat 112 facing toward a footrest 116 at the front of the pedicure cart 104.

In one or more embodiments, the footrest 116 may support a client's feet at an elevated position, such as shown in FIG. 1. This raises the client's feet. In this manner, a technician can easily reach the client's feet. Since the client's feet are raised upward, the technician can also see the client's feet better. The footrest 116 may be padded in one or more embodiments. In addition, it is contemplated that the footrest 116 and/or front portion of the pedicure cart 104 may be height adjustable to position the client's feet at a desired elevated position. An elevator mechanism, such as a screw jack, lift or the like may be used to raiser or lower the footrest 116 in such embodiments.

It is noted that the body 108 may have various shapes. As shown for example, the body 108 has an “L” shape. In this manner, the body 108 supports the seat 112 at a lower elevation than the footrest 116. It is contemplated that the body 108 may be various other shapes. In addition, it is contemplated that the body 108 need not comprise panels in all embodiments. For example, the body 108 may be constructed from a plurality of support members (e.g., beams) arranged to support the seat 112 at the rear of the pedicure cart, and the footrest 116 at the front of the pedicure cart, with the footrest 116 being raised relative to the seat.

The body 108 also supports a curing device 120 at the front of the pedicure cart 104. In general, the curing device 120 is used to dry or otherwise cure nail treatments (e.g., nail polish and the like) applied during the pedicure process. For example, a curing device 120 may utilize light, heat, a fan, or various combinations thereof to cure a nail treatment onto a client's toenail. Curing is advantageous in that it speeds up the nail treatment's application process and helps ensure the coatings applied to a toenail are properly cured before the pedicure proceeds and before the client leaves the technician's place of work.

As can be seen, the curing device 120 may comprise an opening 124 configured to accept a client's feet (or foot). Typically, the opening 124 will be oriented such that it faces the client. In this manner, the client can easily and comfortably position her toenails in the curing device 120 while at the pedicure stand 104.

The pedicure cart 104 may have a cavity in its body 108 to accept and support the curing device 120. The pedicure cart 104 may have one or more power outlets in some embodiments, to provide electrical power to the curing device. It is contemplated that the curing device 120 may be removable for repair and/or maintenance.

The pedicure cart 104 may be mobile in one or more embodiments. For example, as shown in FIG. 1, the pedicure cart 104 includes casters or wheels 128 to allow the pedicure cart to be easily moved. This allows the cart to be positioned easily relative to a client before beginning the pedicure process. The wheels 128 may have one or more braking mechanisms to lock or hold the pedicure cart 104 in place once a desired location is achieved.

FIG. 2 provides a back perspective view of a pedicure cart 104. This view permits a work area 204 of the pedicure cart 104 to be seen. As can be seen, the work area 204 may be located between the footrest 116 and seat 112 in one or more embodiments. In addition, the work area 204 may include a support surface upon which a technician's tools, such as brushes or other applicators, nail polish, powder, gel, files, and the like can be conveniently placed.

In one or more embodiments, the work area 204 may provide access to the curing device 120. For example, as shown in FIG. 2, an opening 208 is provided to allow the technician to access a cavity in the pedicure cart that contains the curing device. The technician may thus control the curing device through this opening, such as by turning the curing device up, down, on, or off. In some embodiments, the technician may turn on/off or adjust various curing elements of the curing device 120. For instance, the technician may adjust a heater, lighting, or fan individually. It is noted that compartment may be provided in the cavity (and accessible via the opening 208) to store technician tools as well.

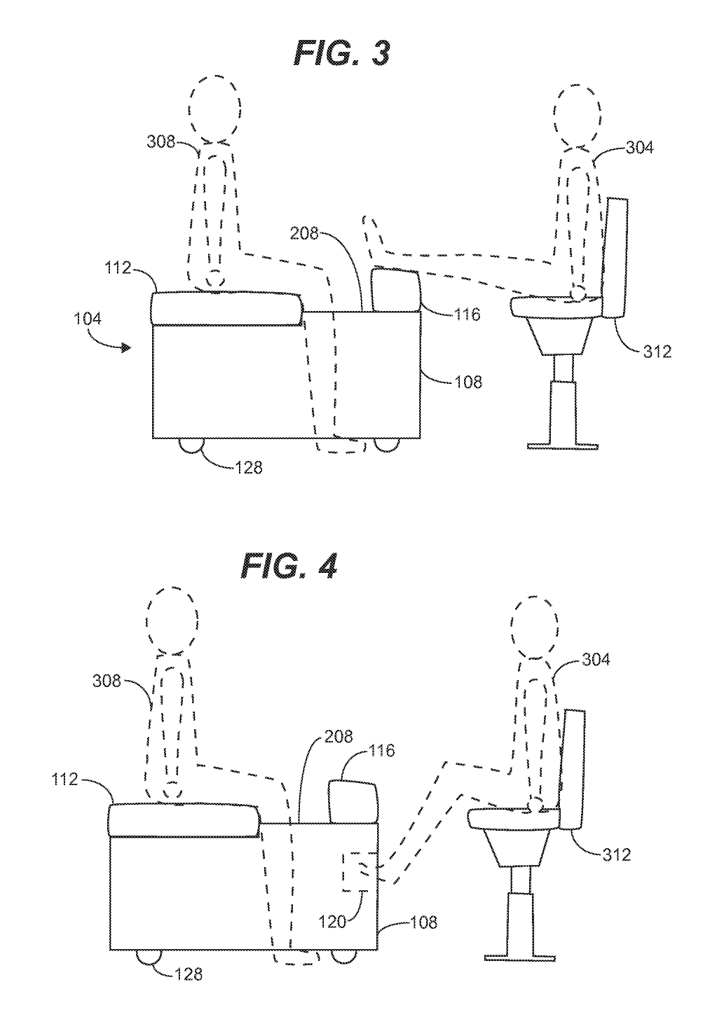

Operation of the pedicure cart will now be described with reference to FIGS. 3-4, which show a technician 308 applying a pedicure to a client 304 with the pedicure cart 104. As can be seen, the pedicure cart 104 may support the technician 308, such as on its seat 112, so that the technician can be seated while facing the client 304. This improves the technician's comfort allowing a number of pedicures to be given at a consistent quality. As shown in FIG. 3, the client's feet 312 (both or individually) may be supported by the footrest 116 during a pedicure treatment, while the remainder of the client's body may be seated in a chair or seat 316. This positions the client's feet 312 at an elevated position easily reached by the technician. In addition, the client is comfortably seated for a pedicure treatment in this manner. As stated above, the pedicure cart 104 may be mobile in one or more embodiments to permit the cart to be easily moved to the client's chair 316.

If one or more toenail coatings, such as nail polish, powder, gel, or other decorative items are applied, the client's feet 312 (or toes/toenails at least) may be easily placed in the curing device 120, such as shown in FIG. 4. In this manner, the coating(s) can be cured by the curing device 120 during the pedicure treatment. This ensures that each coating is cured (i.e., properly applied) before the pedicure proceeds, or before the client leaves. In this way, pedicures of a consistent quality can be provided, even in volume.

It is contemplated that one of the client's feet 312 may be placed in the curing device 120 while the client's other foot is being treated by the technician 308. This speeds the pedicure process by curing the treatment on one foot 312 while allowing the process to continue on the other foot. Waiting time for one or more toenail coatings can be greatly reduced, if not eliminated in this manner.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

1. A pedicure cart comprising:
a body having a front and a back end;
a seat at the back end configured to support a technician;
a footrest at the front end configured to support at least one of a client's feet, the footrest being elevated above the seat to support the at least one of the client's feet at an elevated position; and
a curing device at the front end configured to accept at least a portion of the at least one of the client's feat.

2. The pedicure cart of claim 1 further comprising one or more wheels attached to a bottom portion of the body.

3. The pedicure cart of claim 1 further comprising a cavity in the body, wherein the curing device is supported within the cavity.

4. The pedicure cart of claim 3 further comprising an opening in the top of the body configured to provide access to one or more controls of the curing device.

5. The pedicure cart of claim 1, wherein the footrest comprises a pad.

6. The pedicure cart of claim 1, wherein the curing device is positioned below the footrest.

7. The pedicure cart of claim 1, wherein the curing device further comprises an opening at the front end of the pedicure cart.

8. The pedicure cart of claim 1 further comprising a support surface between the seat and footrest, the support surface configured to support one or more technician tools thereon.

9. The pedicure cart of claim 1, wherein a top portion of the body is lower at the back end than at the front end of the pedicure cart.

10. A pedicure cart comprising:
a seat at a back portion of the pedicure cart;
a footrest at a front portion of the pedicure cart, the footrest configured to support at least one foot at an elevated position above the seat;
a curing device having an opening to accept the at least one foot, the opening positioned at the front portion of the pedicure cart;
a body configured to support the seat and the footrest;
a cavity within the body configured to support the curing device therein; and
one or more wheels attached to a bottom portion of the body.

11. The pedicure cart of claim 1, wherein at least one of the one or more wheels has a brake.

12. The pedicure cart of claim 1, wherein the cavity further comprises one or more compartments configured to store one or more technician tools.

13. The pedicure cart of claim 1, wherein the curing device comprises a curing element selected from the group consisting of a heater, a light, and a fan.

14. The pedicure cart of claim 1, wherein the seat is padded.

15. The pedicure cart of claim 1, wherein the footrest comprises a pad.

16. A method of providing a pedicure treatment using a pedicure cart comprising:
supporting at least one of a client's feet at an elevated position on a footrest at a front end of the pedicure cart;
applying one or more toenail treatments to the at least one of the client's feet while the at least one of the client's feet are on the footrest;
lowering the at least one of the client's feet from the elevated position;
accepting the at least one of the client's feet in a curing device at the front end of the pedicure cart, the curing device having an opening to accept the at least one of the client's feet below the footrest; and
activating the curing device to cure at least one of the one or more toenail treatments.

17. The method of claim 16 further comprising placing one or more tools on a work surface of the pedicure cart that is located adjacent the footrest, and using the one or more tools to apply the one or more toenail treatments.

18. The method of claim 16 further comprising retrieving one or more tools from a cavity in a body of the pedicure cart, and using the one or more tools to apply the one or more toenail treatments.

19. The method of claim 16 further comprising moving the pedicure cart to a client's chair on one or more wheels of the pedicure cart.

20. The method of claim 16 further comprising sitting on a seat located at a back end of the pedicure cart, wherein the elevated position is above the seat.
